(19) United States
(12) Patent Application Publication
(10) Pub. No.: US 2020/0086868 A1
(43) Pub. Date: Mar. 19, 2020

(54) APPARATUS AND METHOD FOR CONTROLLING DRIVING OF A VEHICLE

(71) Applicants: HYUNDAI MOTOR COMPANY, Seoul (KR); KIA MOTORS CORPORATION, Seoul (KR)

(72) Inventors: Hai Jin Seo, Yongin-si, Gyeonggi-do (KR); Si Jun Kim, Seoul (KR)

(73) Assignees: HYUNDAI MOTOR COMPANY, Seoul (KR); KIA MOTORS CORPORATION, Seoul (KR)

(21) Appl. No.: 16/202,715

(22) Filed: Nov. 28, 2018

(30) Foreign Application Priority Data
Sep. 14, 2018 (KR) 10-2018-0110478

(51) Int. Cl. B60W 30/16

(52) U.S. Cl. CPC B60W 30/16; B60W 2720/10; B60W 2750/302; B60W 2750/308; B60W 2720/106

(57) ABSTRACT

An apparatus and a method for controlling driving of a vehicle include: a data collecting device configured to collect data for driving scenarios defined according to driving conditions; a pattern generating device configured to generate patterns corresponding to the driving scenarios by analyzing the data collected for the driving scenarios; a determination device configured to determine a current driving situation of the vehicle and to determine a control scenario corresponding to the current driving situation; and a controller configured to generate control data based on a pattern corresponding to at least one driving scenario matched with the control scenario and control driving of the vehicle based on the generated control data.

### CROSS-REFERENCE TO RELATED APPLICATION

This application claims the benefit of priority to Korean Patent Application No. 10-2018-0110478, filed in the Korean Intellectual Property Office on Sep. 14, 2018, the entire contents of which are incorporated herein by reference.

### BACKGROUND

### Technical Field

The present disclosure relates to an apparatus and a method for controlling driving of a vehicle.

### Description of Related Art

An advanced driver assistance system (ADAS) according to the related art controls a distance of a host vehicle from a front vehicle by recognizing a flow of traffic around the host vehicle or controls the distance of the host vehicle according to a distance or an acceleration sensitivity set by the user.

When the ADAS system performs a longitudinal control of the host vehicle, a control condition for a distance from the front vehicle and the host vehicle and deceleration/acceleration is fixed by stages.

For example, the ADAS system performs a longitudinal control of the vehicle by classifying a driving tendency of the driver into levels 1, 2, or 3 (i.e. a mild level, a normal level, or an aggressive level). The levels are changed according to a condition.

The levels overly simplify the driving tendencies of the driver and fail to reflect all the various driving tendencies of the driver. Accordingly, the driver may feel disconnected from the vehicle, inconvenienced, and/or unsafe when the ADAS system performs the longitudinal control of the vehicle.

### SUMMARY

The present disclosure is made to solve the above-mentioned problems occurring in the prior art, while advantages achieved by the prior art are maintained intact.

An aspect of the present disclosure provides improved satisfaction of a driver for a longitudinal braking control of the vehicle by collecting driving data of the driver for scenarios defined for various driving conditions, analyzing patterns of the driving data, and reflecting the to matched patterns in response to a longitudinal control situation based on velocity of the vehicle.

The technical problems to be solved by the present disclosure are not limited to the aforementioned problems. Any other technical problems not mentioned herein will be clearly understood from the following description by those having ordinary skill in the art to which the present disclosure pertains.

In accordance with an aspect of the present disclosure, an apparatus for controlling driving of a vehicle is provided. The apparatus includes a data collecting device configured to collect data for driving scenarios defined according to driving conditions, a pattern generating device configured to generate patterns corresponding to the driving scenarios by analyzing the data collected for the driving scenarios, a determination device configured to determine a current driving situation of the vehicle and decide on a control scenario corresponding to the current driving situation, and a controller configured to generate control data based on a pattern corresponding to at least one driving scenario matched with the control scenario and control driving of the vehicle.

The driving scenarios may be defined in correspondence to at least one driving condition of a distance from a front vehicle, a pursuit acceleration amount, a maximum acceleration amount, a time point of a cut-out acceleration, and a time point of a cut-in deceleration.

The pattern generating device may generate patterns of change of a front vehicle distance, an acceleration, an acceleration time, or a deceleration time according to a change of a velocity of the vehicle from the data collected for the driving scenarios.

The apparatus may further include a pattern matching device configured to match the patterns generated for the driving scenarios with reference patterns that are generated in advance according to the driving conditions.

The pattern matching device may determine similarities of the patterns generated for the driving scenarios and the reference patterns to compare the patterns generated for the driving scenarios with the reference patterns. The patterns may be matched with a reference pattern having the highest similarity.

The data collecting device may determine a driving scenario that agrees with the driving condition when the data is collected. The data collecting device may further store the collected data in correspondence to the determined driving scenario.

The data collecting device may collect data for every specific cycle until a preset data collection condition is satisfied.

The determination device may determine a control scenario based on at least one of a target distance between a front vehicle and a host vehicle, presence of a front vehicle, a distance of the front vehicle, a target velocity of the host vehicle, a current velocity of the host vehicle, and a relative velocity of the front vehicle.

The determination device may determine the control scenario for any one control situation of a front vehicle pursuit control, a target velocity pursuit control, and a cut-in deceleration control according to the current driving situation of the vehicle.

The controller may generate the control data based on at least one control parameter of a required acceleration, an acceleration delay time point, and a deceleration delay time point based on a pattern corresponding to the at least one driving scenario matched with the control scenario.

In accordance with another aspect of the present disclosure, there is provided a method for controlling driving of a vehicle. The method includes collecting data for driving scenarios defined according to driving conditions, generating patterns corresponding to the driving scenarios by analyzing the data collected for the driving scenarios, determining a current driving situation of the vehicle and deciding a control scenario corresponding to the current driving situation, and generating control data based on a pattern corresponding to at least one driving scenario matched with the control scenario and controlling driving of the vehicle.

### BRIEF DESCRIPTION OF THE DRAWINGS

The above and other objects, features, and advantages of the present disclosure will be more apparent from the following detailed description taken in conjunction with the accompanying drawings:

FIG. 1 is a block diagram illustrating a configuration of an apparatus for controlling driving of a vehicle according to an embodiment of the present disclosure;

FIGS. 2-4, 5A-5D, and 6A-6D are views of embodiments that are referenced for explaining operations of the apparatus according to an embodiment of the present disclosure;

FIG. 7 is a block diagram illustrating a vehicle system, to which the apparatus according to an embodiment of the present disclosure is applied;

FIGS. 8 and 9 are a flowchart illustrating flows of operations of a method according to an embodiment of the present disclosure; and

FIG. 10 is a block diagram illustrating a computing system that executes the method according to an embodiment of the present disclosure.

### DETAILED DESCRIPTION

Hereinafter, embodiments of the present disclosure are described in detail with reference to the accompanying drawings. Throughout the specification, the same or like reference numerals denote the same or like components even though they are provided in different drawings. Further, in the following description of the present disclosure, a detailed description of known functions and configurations incorporated herein are omitted when it may make the subject matter of the present disclosure rather unclear.

In addition, terms, such as first, second, A, B, (a), (b), or the like, may be used herein when describing components of the present disclosure. The terms are provided only to distinguish the components from other components. The essences, sequences, orders, and numbers of the components are not limited by the terms. In addition, unless defined otherwise, all terms used herein, including technical or scientific terms, have the same meanings as those generally understood by those having ordinary skill in the art to which the present disclosure pertains. The terms defined in generally used dictionaries should be construed as having meanings that coincide with the meanings of the contexts of the related technologies and should not be construed as ideal or excessively formal meanings unless clearly defined in the specification of the present disclosure.

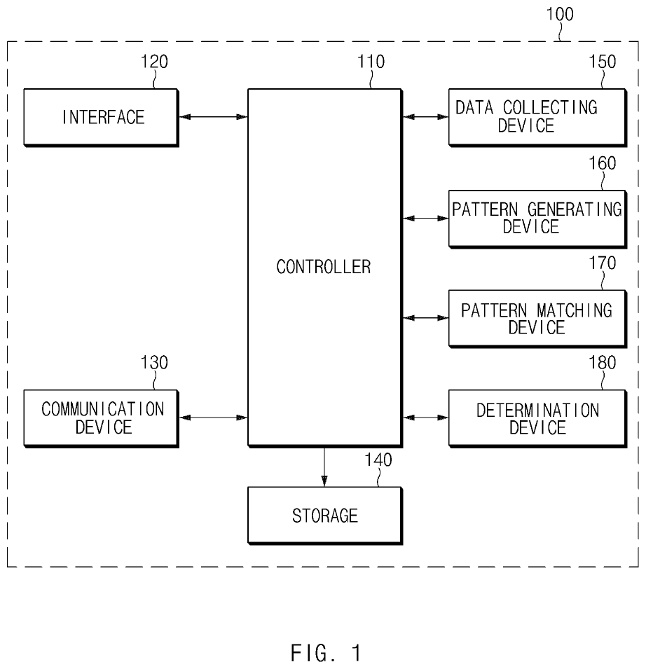

FIG. 1 is a block diagram illustrating a configuration of an apparatus for controlling driving of a vehicle according to an embodiment of the present disclosure.

Referring to FIG. 1, the apparatus 100 for controlling driving of a vehicle may include a controller 110, an interface 120, a communication device 130, a storage 140, a data collecting device 150, a pattern generating device 160, a pattern matching device 170, and a determination device 180. Here, the controller 110, the data collecting device 150, the pattern generating device 160, the pattern matching device 170, and the determination device 180 of the apparatus 100 according to the embodiment may be realized by one or more processors.

The controller 110 may process signals delivered between any two of the components of the apparatus 100.

The interface 120 may include an input unit that receives a control command and an output unit that outputs an operation state and a result of the apparatus 100.

The input unit may include a key button, a mouse, a joystick, a jog shuttle, and a stylus pen. Further, the input unit may include a soft key that is embodied on a display.

The output unit may include a display and a voice output unit, such as a speaker. When a touch sensor (e.g., a touch film, a touch sheet, a touch pad, or the like) is provided in the display, the display may be operated as a touch screen and may be embodied in a form in which an input unit and an output unit are integrated.

The display may include at least one of a liquid crystal display (LCD), a thin film transistor-liquid crystal display (TFT-LCD), an organic light-emitting diode (OLED), a flexible display, afield to emission display (FED), and a 3D display.

The communication device 130 may include a communication module that supports a communication interface with electronic components, sensors, and/or control units included in the vehicle. As an example, the communication module may receive driving information of the vehicle, such as velocity, from the sensors included in the vehicle. Further, the communication module may receive information, such as presence of a front vehicle and a distance between a host vehicle and the front vehicle, from sensors.

The communication module may include a module that supports network communication of the vehicle, such as controller area network (CAN) communication, local interconnect network (LIN) communication, or Flex-Ray communication.

Further, the communication device 130 may include a module for wireless internet connection or a module for short range communication. The wireless internet technology may include wireless LAN (WLAN), wireless broadband (WiBro), Wi-Fi, or world interoperability for microwave access (WiMax). The short range communication technology may include Bluetooth, ZigBee, ultra-wideband (UWB), radio frequency identification (RFID), and infrared data association (IrDA).

The storage 140 may store data and/or algorithms that are necessary for operating the apparatus 100 for controlling driving of the vehicle.

For example, the storage 140 may store driving information of the host vehicle and driving information received from the front vehicle.

Further, the storage 140 may store a plurality of driving scenarios defined for driving conditions in advance and may store a command, a condition, and/or an algorithm for generating patterns for the driving scenarios and matching the patterns.

Further, the storage 140 may store a plurality of control scenarios for driving control of the host vehicle and may store driving scenario information corresponding to the control scenarios. Further, the storage 140 may calculate accelerations required for the control scenarios and may store a command, a condition, and/or an algorithm for generating control data.

The storage 140 may include storage media, such as a random access memory (RAM), a static random access memory (SRAM), a read-only memoiy (ROM), a programmable read-only memory (PROM), and an electrically erasable programmable read-only memoiy (EEPROM).

The data collecting device 150 collects data for the driving scenarios defined according to the driving conditions if the host vehicle is started or turned on. The data collecting device 150 may collect data when a driving control function, such as a smart cruise control (SCC), is off or ready in a state in which the host vehicle is started.

The driving scenarios may be defined in correspondence to at least one driving condition, including a distance from a front vehicle, a pursuit acceleration amount, a maximum acceleration amount, a time point of a cut-out acceleration, and a time point of a cut-in deceleration. Accordingly, the driving scenarios may include a front vehicle distance based driving scenario, a pursuit acceleration amount based driving scenario, a maximum acceleration amount based driving scenario, a cut-out acceleration time point based driving scenario, and/or a cut-in deceleration time point based driving scenario.

The data collecting device 150 identifies data required for the driving scenarios and collects the identified data. As an example, the data collecting device 150 may collect data, such as a velocity, an acceleration, a deceleration, an acceleration time, and/or a deceleration time of the vehicle that is traveling for the driving scenarios. Further, the data collecting device 150 may collect data, such as presence of a front vehicle and a distance between the front vehicle and the host vehicle, when the front vehicle is present.

The data collecting device 150 may collect data at every preset cycle. The data collecting device 150 determines a driving scenario that agrees with the driving condition during the collection of data and stores the collected data in correspondence to the determined driving scenario.

As an example, the data collecting device 150 may determine a front vehicle distance based driving scenario that agrees with driving condition A. In the driving condition A, a front vehicle is present in a state in which there is no change in the velocity of the host vehicle and in which there is no change in the distance of the front vehicle. The data collecting device 150 may store data corresponding to the velocity of the host vehicle and the distance of the front vehicle, which have been collected, in correspondence to the front vehicle distance based driving scenario.

The data collecting device 150 may determine a pursuit acceleration amount based driving scenario that agrees with driving condition B. In the driving condition B, there is a front vehicle in a state in which the host vehicle is accelerating. The data collecting device 150 may store data corresponding to the velocity and the acceleration of the host vehicle, which have been collected, in correspondence to the pursuit acceleration amount based driving scenario.

The data collecting device 150 may determine a maximum acceleration amount based driving scenario that agrees with driving condition C. In the driving condition C, there is no front vehicle in a state in which the host vehicle is accelerating. The data collecting device 150 may store data corresponding to the velocity and the acceleration of the host vehicle, which have been collected, in correspondence to the maximum acceleration amount based driving scenario.

The data collecting device 150 may determine a cut-out acceleration time point based driving scenario that agrees with driving condition D. In the driving condition D, the host vehicle is accelerated in a state in which the front vehicle is cut out or the distance of the front vehicle increases. The data collecting device 150 may store data corresponding to the velocity and the acceleration time of the host vehicle, which have been collected, in correspondence to the cut-out acceleration time point based driving scenario.

The data collecting device 150 may determine a cut-in deceleration time point based driving scenario that agrees with driving condition E. In the driving condition E, the front vehicle is cut in and the host vehicle is decelerated. The data collecting device 150 may store data corresponding to the velocity and the deceleration time of the host vehicle, which have been collected, in correspondence to the cut-in deceleration time point based driving scenario.

The data collecting device 150 may collect data for every specific cycle until a preset data collection condition is satisfied. The data collecting device 150 may stop collecting data if the data collection condition is satisfied.

As an example, the data collecting device 150 may stop collecting data when the amount of data that are buffered for the driving scenarios exceeds a reference amount. Meanwhile, the data collecting device 150 may stop collecting data if a vehicle driving control function, for example a smart cruise control (SCC) function, is enabled.

The pattern generating device 160 generates patterns corresponding to the driving scenarios by analyzing the data collected for the driving scenarios by the data collecting device 150. The pattern generating device 160 may generate change patterns of the front vehicle distance, the acceleration, the acceleration time, and the deceleration time according to the change of the velocity of the vehicle from the data collected for the driving scenarios.

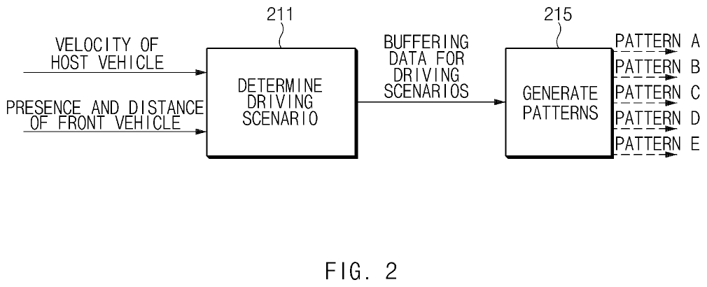

FIG. 2 is referenced for an embodiment of the operation of generating a pattern corresponding to a driving scenario by determining the driving scenario.

Referring to FIG. 2, the data collecting device 150 determines a driving scenario for the current driving condition based on collected data if data, such as the velocity of the host vehicle, presence of a front vehicle, and a distance of the front vehicle, are collected from the host vehicle that is traveling. The data collecting device 150 buffers and stores the collected data in correspondence to the determined driving scenario.

As an example, when the data collected by the data collecting device 150 in driving condition A is buffered in correspondence to driving scenario A, the pattern generating device 160 generates pattern A by using the data buffered in correspondence to driving scenario A.

When the data collected by the data collecting device 150 in driving condition B is buffered in correspondence to driving scenario B, the pattern generating device 160 generates pattern B by using the data buffered in correspondence to driving scenario B.

In this way, the pattern generating device 160 may generate patterns A to E by using the data buffered for the driving scenarios.

For example, the pattern generating device 160 may dispose data corresponding to the front vehicle distances, the accelerations, the acceleration times, and/or the deceleration times for the velocities on a 2-dimensional plane with reference to the velocity data. The pattern generating device 160 may generate a driving pattern corresponding to the driving scenario by performing polynomial fitting for the data disposed in a 2-dimensional plane.

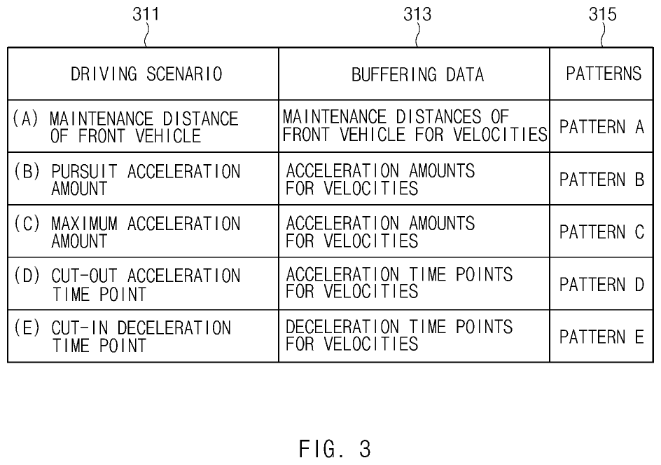

FIG. 3 is referenced for the embodiment for the driving patterns generated in correspondence to the driving scenarios.

FIG. 3 illustrates a driving scenario 311, buffering data 313, and a driving pattern 315 generated in correspondence to the data in a table.

As illustrated in FIG. 3, the data collecting device 150 may buffer a maintenance distance data of a front vehicle for the velocity in correspondence to the maintenance distance of the front vehicle distance based driving scenario A. The pattern generating device 160 may generate pattern A by using the data buffer in correspondence to the maintenance distance of the front vehicle based driving scenario.

The data collecting device 150 may buffer the acceleration data for the velocities in correspondence to a pursuit acceleration amount based driving scenario B. The pattern generating device 160 may generate pattern B by using the data buffered in correspondence to the pursuit acceleration amount based driving scenario.

The data collecting device 150 may buffer the acceleration data for the velocities in correspondence to a maximum acceleration amount based driving scenario C. The pattern generating device 160 may generate pattern C by using the data buffered in correspondence to the to pursuit acceleration amount based driving scenario.

The data collecting device 150 may buffer the acceleration times for the velocities in correspondence to a cut-out acceleration time point based driving scenario D. The pattern generating device 160 may generate pattern D by using the data buffered in correspondence to the cut-out acceleration time point based driving scenario.

The data collecting device 150 may buffer the deceleration times for the velocities in correspondence to a cut-in deceleration time point based driving scenario E. The pattern generating device 160 may generate pattern E by using the data buffered in correspondence to the cut-in deceleration time point based driving scenario.

If the patterns for the driving scenarios are generated by the pattern generating device 160, the pattern matching device 170 matches the patterns generated for the driving scenarios with reference patterns, which were generated in advance according to a driving condition.

Here, the reference pattern is generated by using a sufficiently large number of driving data for the driving conditions. Accordingly, when the driving patterns generated based on the driving data of the driver are matched with the reference patterns, the safety of the system may be improved because various driving patterns of the driver are reflected.

A plurality of reference patterns may be generated for the driving conditions. Accordingly, after comparing the patterns generated for the driving scenarios and the plurality of reference patterns, their similarities are determined. The pattern matching device 170 then matches the patterns with the reference pattern having the highest similarity.

The data collecting device 150, the pattern generating device 160, and the pattern matching device 170 may be operated when the driving control function, such as a smart cruise control (SCC), is off or ready in a state in which the host vehicle is started.

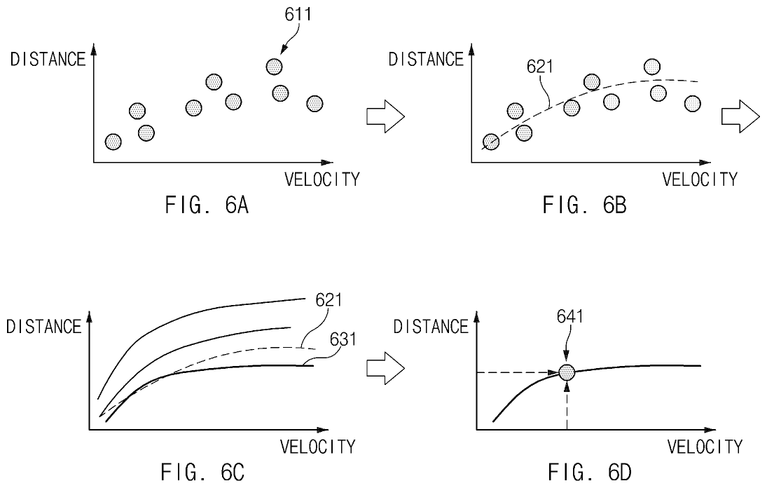

As an example, FIGS. 6A-6D are referenced for an embodiment of a series of operations of collecting data 611 for the maintenance distance of the front vehicle based driving scenario, generating a pattern 621, and matching the generated pattern 621 with a reference pattern 631.

Meanwhile, if the smart cruise control (SCC) function is turned on to be enabled, a determination device 180 may be operated.

If the driving control function, such as a smart cruise control (SCC), is enabled, the determination device 180 determines a current driving situation of the vehicle and decides a control scenario corresponding to the current driving situation.

The control scenario may include a front vehicle pursuit control based control scenario, a target velocity pursuit control based control scenario, and/or a cut-in deceleration control based control scenario. At least one driving scenario may be matched with the control scenarios.

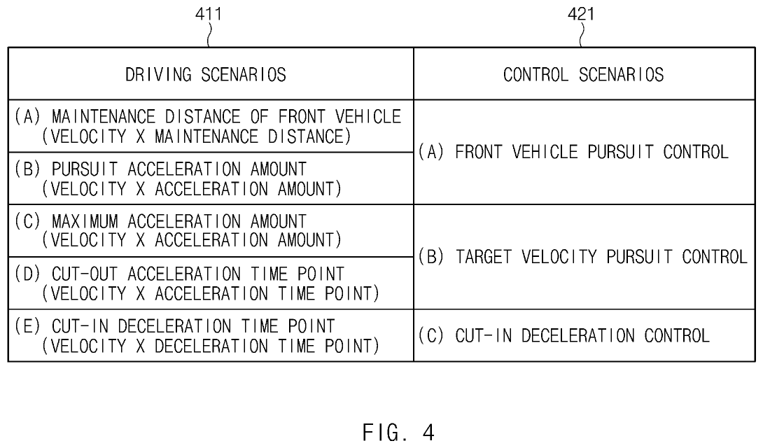

FIG. 4 is referenced for an embodiment for driving scenarios matched with the control scenarios.

FIG. 4 illustrates a matching structure of a driving scenario 411 and a control scenario 421 in a table. Referring to FIG. 4, a maintenance distance of a front vehicle based driving scenario and a pursuit acceleration amount based driving scenario may be matched with a front vehicle pursuit control based control scenario A. A maximum acceleration amount based driving scenario and a cut-out acceleration time point based driving scenario may be matched with a target velocity pursuit control based control scenario B. A cut-in deceleration time point based driving scenario may be matched with a cut-in deceleration control based control scenario C.

The determination device 180 may determine a control scenario corresponding to a current driving situation based on a target distance between a front vehicle and the host vehicle, presence of a front vehicle, a distance of the front vehicle, a target velocity of the host vehicle, a current velocity of the host vehicle, and/or a relative velocity of the front vehicle.

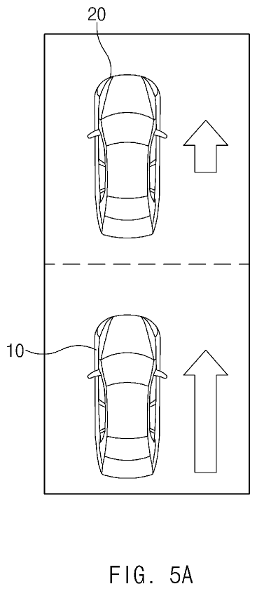

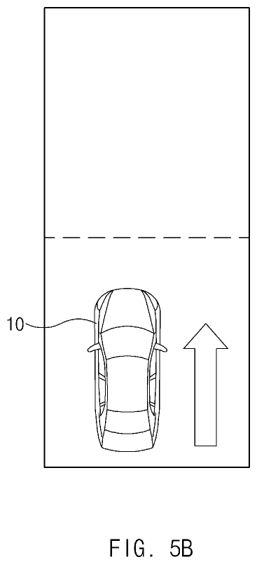

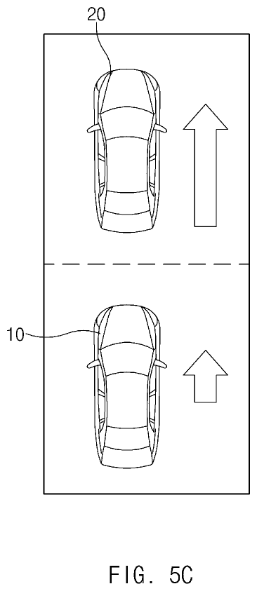

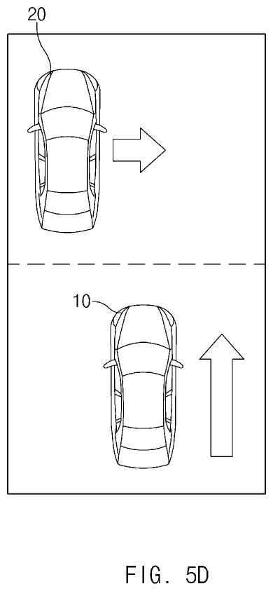

As an example, as illustrated in FIG. 5A, when a front vehicle 20 is present within a target distance of the front side from the host vehicle 10 and the velocity of the front vehicle 20 is lower than (or the same as) a target velocity of the vehicle 10, the determination device 180 may determines a front vehicle pursuit control based control scenario as a control scenario corresponding to the current driving situation.

In this case, the control device 110 generates control data for controlling driving of the host vehicle 10 based on pattern A corresponding to a maintenance distance of a front vehicle based driving scenario matched with the front vehicle pursuit control based control scenario and pattern B corresponding to the pursuit acceleration amount based driving scenario.

The controller 110 determines a control parameter, for example a required acceleration, based on pattern A and pattern B.

Here, the controller 110 may calculate a required acceleration according to a relative distance by using Equation 1.

a_{d}=β_{d}·ƒ₂(vₑ)·(d_{ƒ}−ƒ₁(vₑ)) [Equation 1]

In Equation 1, α_{d} denotes a required acceleration according to a relative distance, β_{d} denotes a required acceleration weight according to a relative distance, Vₑ denotes a velocity of a host vehicle, d_{f} denotes a relative distance between a front vehicle and a host vehicle, f₁ denotes a function (velocity-distance) of pattern A, and f₂ denotes a function (velocity-acceleration) of pattern B.

Further, the controller 110 may calculate a required acceleration according to a relative distance by using Equation 2.

aᵥ=βᵥ*ƒ₂(vₑ)*(v_{ƒ}−vₑ) [Equation 2]

In Equation 2, αᵥ denotes a required acceleration according to a relative velocity, βᵥ denotes a required acceleration weight according to a relative velocity, vₑ denotes a velocity of a host vehicle, v_{f} denotes a velocity of a front vehicle, and f₂ denotes a function (velocity-acceleration) of pattern B

The controller 110 generates control data based on the smaller of the required acceleration to according to the relative distance calculated from Equation 1 and the required acceleration according to the relative velocity calculated from Equation 2.

Accordingly, the controller 110 performs a front vehicle pursuit control of the host vehicle according to the generated control data.

As illustrated in FIG. 5B, when a front vehicle 20 is not present within a target distance of the front side from the host vehicle 10, the determination device 180 may determine a target velocity pursuit control based control scenario as a control scenario corresponding to the current driving situation.

As illustrated in FIG. 5C, when a front vehicle 20 is present within a target distance of the front side from the host vehicle 10 and the velocity of the front vehicle 20 is higher than (or the same as) a target velocity of the vehicle 10, the determination device 180 may determine a target velocity pursuit control based control scenario as a control scenario corresponding to the current driving situation.

In this case, the control device 110 generates control data for controlling driving of the host vehicle 10 based on pattern C, which corresponds to a maximum acceleration amount based driving scenario matched with the target velocity pursuit control based control scenario, and pattern D, which corresponds to the cut-out acceleration time point based driving scenario.

The controller 110 determines control parameters, for example a required acceleration and an acceleration delay time based on pattern C and pattern D.

In this example, the controller 110 may calculate a required acceleration by using Equation 3.

aₜ=βₜ×(vₜ−vₑ) [Equation 3]

In Equation 3, αₜ denotes a required acceleration according to a difference between a current velocity and a target velocity of a host vehicle, βₜ denotes a required acceleration weight according to the distance between the current velocity and the target velocity of the host vehicle, vₜ denotes a target velocity of the host vehicle, and vₑ denotes a current velocity of the host vehicle.

The controller 110 may determine a function f₃(vₑ) value of pattern C as a required acceleration when a required acceleration calculated from Equation 3 is smaller than a function f₃(vₑ) of pattern C.

The controller 110 may calculate an acceleration delay time by using Equation 4.

t₁=ƒ₄(vₑ) [Equation 4]

In Equation 4, t₁ denotes an acceleration delay time when a front vehicle pursuit control scenario is changed to a target velocity pursuit control scenario, vₑ denotes a velocity of a host vehicle, and f₄ denotes a function (velocity-acceleration time) of pattern D.

The controller 110 generates control data based on the required acceleration calculated from Equation 3 and the acceleration delay time calculated from Equation 4.

Accordingly, the controller 110 performs a front vehicle pursuit control of the host vehicle according to the generated control data.

As illustrated in FIG. 5D, when a front vehicle 20 enters a target distance on the front side from the host vehicle 10, the determination device 180 may determine a cut-in deceleration control based control scenario as a control scenario corresponding to the current driving situation.

In this case, the controller 110 generates control data for controlling driving of the host vehicle 10 based on pattern E, which corresponds to the cut-in deceleration time point based driving scenario matched with the cut-in deceleration control based control scenario.

The controller 110 determines a control parameter, for example a deceleration delay time based on pattern E.

The controller 110 may calculate a deceleration delay time by using Equation 5.

t₂=ƒ₅(vₑ) [Equation 5]

In Equation 5, t₂ denotes a deceleration delay time when a cut-in situation of the front vehicle is generated, vₑ denotes a velocity of the host vehicle, and f₅ denotes a function (velocity−deceleration time) of pattern E.

The controller 110 generates control data based on the deceleration delay time calculated from Equation 5.

Accordingly, the controller 110 performs a cut-in deceleration control of the host vehicle according to the generated control data.

The apparatus 100 according to the embodiment, which is operated as mentioned above, may be realized in a form of a memory and a hardware device, including a process that processes operations, and may be driven in a form in which the fuel cell life span predicting apparatus is included in another hardware device, such as a microprocessor or a general-purpose computer system.

The apparatus 100 for controlling driving of a vehicle according to the present disclosure may be embodied in the interior of the vehicle. The apparatus 100 for controlling driving of a vehicle may be integrally formed with control units in the interior of the vehicle and may be embodied as a separate apparatus to be connected to the control units of the vehicle by a separate connection unit. Further, the apparatus 100 for controlling driving of a vehicle may be an apparatus that constitute an advanced driver assistance system (ADAS).

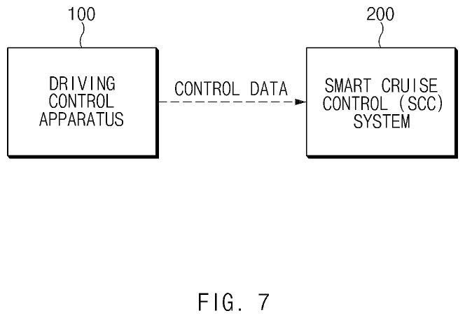

FIG. 7 is a block diagram illustrating a vehicle system, to which the apparatus according to an embodiment of the present disclosure is applied.

As illustrated in FIG. 7, the vehicle system may include an apparatus 100 for controlling driving of a vehicle and a smart cruise control (SCC) system 200.

In this case, the apparatus 100 for controlling driving of a vehicle generates control data according to control scenarios in the embodiments of FIGS. 1 to 6D and provides the generated control data to a smart cruise control (SCC) system 200. The smart cruise control (SCC) system 200 is a system that automatically supports driving of the host vehicle for supporting driving ofthe driver.

Accordingly, the smart cruise control (SCC) system 200 may control driving of the vehicle based on the control data received from the driving control device 100.

Flowcharts of the operations of the apparatus for controlling driving of a vehicle according to the present disclosure is described in detail.

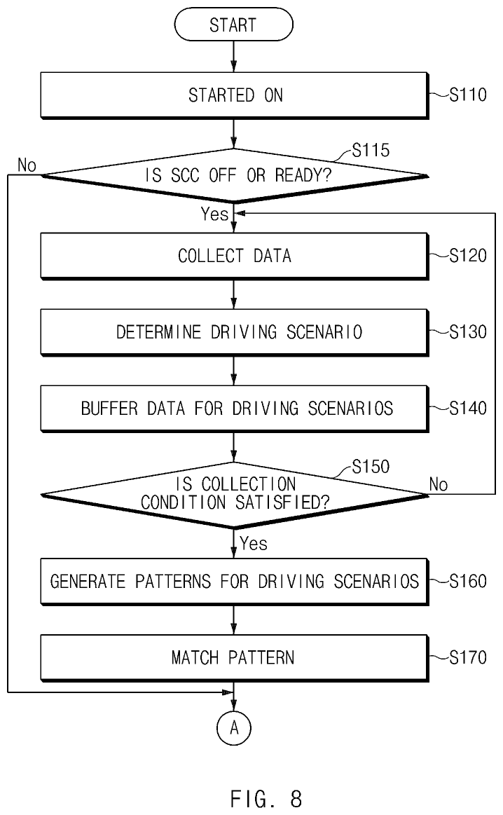

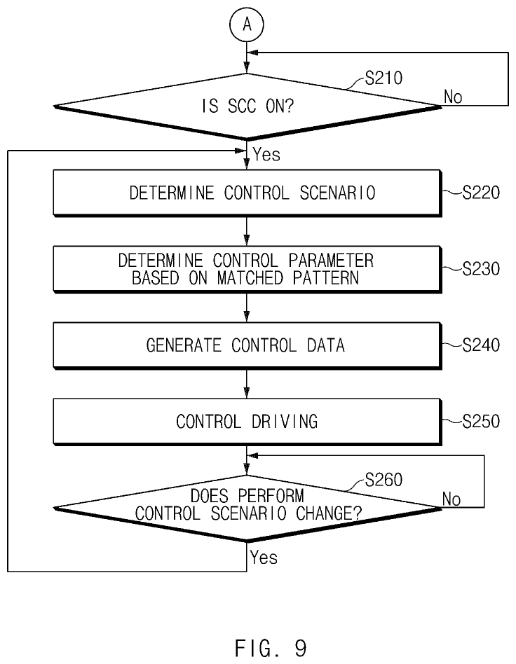

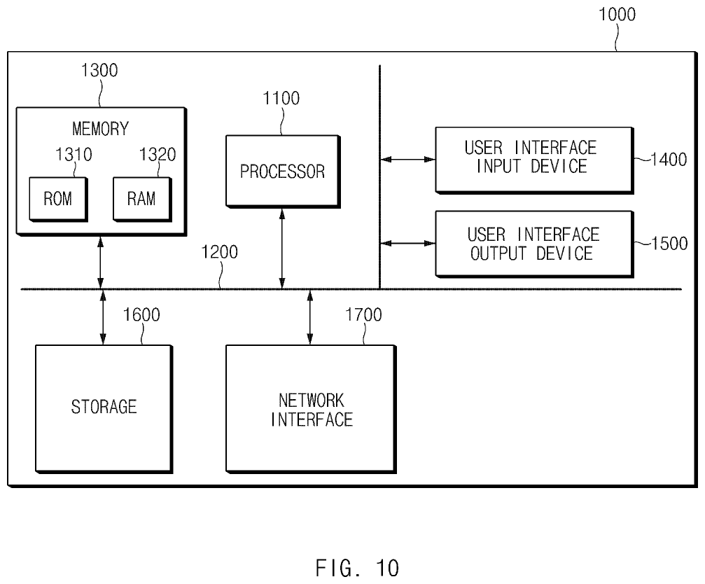

FIGS. 8 and 9 illustrate a flowchart showing operations of a method according to an embodiment of the present disclosure.

FIG. 8 illustrates operations of generating patterns by collecting driving data of the driver for the driving scenarios.

Referring to FIG. 8, the apparatus 100 for controlling driving of a vehicle collects data for driving scenarios defined according to driving conditions (S120) when the host vehicle is turned on (S110) and the vehicle is operated while a driving control function such as a smart cruise control (SCC) is off or ready (S115).

The apparatus 100 for controlling driving of the vehicle determines a driving scenario corresponding to the corresponding driving condition based on the data collected in process S120 (S130) and buffers the data collected in process S120 to the corresponding driving scenario according to a determination result (S140).

If a collection condition is satisfied in process S150, the apparatus 100 for controlling driving of the vehicle generates patterns by using the data buffered to the driving scenarios in process S140 (S160). If the collection condition is not satisfied in process S150, the apparatus 100 for controlling driving of the vehicle may perform processes S120 to S140 for every preset cycle.

The apparatus 100 for controlling driving of the vehicle matches the patterns generated for the driving scenarios in process S160 with reference patterns generated in advance (S170).

Thereafter, the apparatus 100 for controlling driving of the vehicle performs the processes after A of FIG. 9.

FIG. 9 illustrates an operation of controlling the vehicle by generating control data for control scenarios by using the patterns of the driving scenarios generated by the operations of FIG. 8.

Referring to FIG. 9, the apparatus 100 for controlling driving of the vehicle determines a control scenario corresponding to a current driving situation of a host vehicle based on driving data of the vehicle (S220) if the smart cruise control (SCC) function is on (S210).

The apparatus 100 for controlling driving of the vehicle determines a control parameter based on a pattern corresponding to at least one driving scenario matched with the determined control scenarios if the control scenario is determined in process S220 (S230) and generates control data for controlling driving of the host vehicle based on the control parameter determined in process S230 (S240).

The apparatus 100 for controlling driving of the vehicle controls driving of the host vehicle based on the control data generated in process S240 (S250).

If the apparatus 100 for controlling driving of the vehicle performs a control scenario change (S260), the apparatus 100 for controlling driving of the vehicle performs processes S220 to S250 again.

FIG. 10 is a block diagram illustrating a computing system that executes the method according to an embodiment of the present disclosure.

Referring to FIG. 10, the computing system 1000 may include at least one processor 1100 connected through a bus 1200, a memory 1300, a user interface input device 1400, a user interface output device 1500, a storage 1600, and a network interface 1700.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the steps of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM memory, a flash memory, a ROM memory, an EPROM memory, an EEPROM memory, a register, a hard disk, a detachable disk, or a CD-ROM. The storage medium is coupled to the processor 1100. The processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the present disclosure, a satisfaction of a driver for a longitudinal braking control of the vehicle may be improved by collecting driving data of the driver for scenarios defined for various driving conditions, analyzing patterns of the driving data, and reflecting the matched patterns in response to a longitudinal control situation based on velocity.

The above description is a simple exemplification of the technical spirit of the present disclosure. The present disclosure may be variously corrected and modified by those having ordinary skill in the art to which the present disclosure pertains without departing from the essential features of the present disclosure.

Therefore, the disclosed embodiments of the present disclosure do not limit the technical spirit of the present disclosure but are illustrative. The scope of the technical spirit of the present disclosure is not limited by the embodiments of the present disclosure. The scope of the present disclosure should be construed by the claims. It will be understood that all the technical spirits within the equivalent range fall within the scope of the present disclosure.

What is claimed is:

1. An apparatus for controlling driving of a vehicle, the apparatus comprising:
a data collecting device configured to collect data for driving scenarios defined according to driving conditions;
a pattern generating device configured to generate patterns corresponding to the driving scenarios by analyzing the data collected for the driving scenarios;
a determination device configured to determine a current driving situation of the vehicle and to determine a control scenario corresponding to the current driving to situation; and
a controller configured to generate control data based on a pattern, of the generated patterns, corresponding to at least one driving scenario, of the driving scenarios, matched with the control scenario and control driving of the vehicle based on the generated control data.

2. The apparatus of claim 1, wherein the driving scenarios are defined in correspondence to at least one driving condition of the current driving conditions, of a distance from a front vehicle, a pursuit acceleration amount, a maximum acceleration amount, a time point of a cut-out acceleration, a time point of a cut-in deceleration, or a combination thereof.

3. The apparatus of claim 1, wherein the pattern generating device generates patterns of change of a front vehicle distance, an acceleration, an acceleration time, a deceleration time, or a combination thereof according to a change of a velocity of the vehicle from the data collected for the driving scenarios.

4. The apparatus of claim 1, further comprising:
a pattern matching device configured to match the patterns generated for the driving scenarios with reference patterns generated in advance according to the driving conditions.

5. The apparatus of claim 4, wherein the pattern matching device determines similarities of the patterns generated for the driving scenarios and the reference patterns to compare the patterns generated for the driving scenarios with the reference patterns and matches the patterns with a reference pattern, of the reference patterns, having a highest similarity.

6. The apparatus of claim 1, wherein the data collecting device determines a driving scenario, of the driving scenarios, that agrees with a driving condition, of the driving conditions, when the data is collected and stores the collected data in correspondence to the determined driving scenario.

7. The apparatus of claim 1, wherein the data collecting device collects data for every specific cycle until a preset data collection condition is satisfied.

8. The apparatus of claim 1, wherein the determination device determines the control scenario based on at least one of a target distance between a front vehicle and a host vehicle, presence of a front vehicle, a distance of the front vehicle, a target velocity of the host vehicle, a current velocity of the host vehicle, and a relative velocity of the front vehicle.

9. The apparatus of claim 1, wherein the determination device determines the control scenario for a control situation based on at least one of a front vehicle pursuit control, a target velocity pursuit control, and a cut-in deceleration control according to the current driving situation of the vehicle.

10. The apparatus of claim 1, wherein the controller generates the control data based on at least one control parameter of a required acceleration, an acceleration delay time point, and a deceleration delay time point based on a pattern, of the patterns, corresponding to the at least one driving scenario matched with the control scenario.

11. A method for controlling driving of a vehicle, the method comprising:
collecting data for driving scenarios defined according to driving conditions;
generating patterns corresponding to the driving scenarios by analyzing the data collected for the driving scenarios;
determining a current driving situation of the vehicle and determining a control scenario corresponding to the current driving situation; and
generating control data based on a pattern, of the patterns, corresponding to at least one driving scenario, of the driving scenarios, matched with the control scenario and controlling driving of the vehicle based on the generated control data.

12. The method of claim 11, wherein the driving scenarios are defined in correspondence to at least one driving condition, of the driving conditions, of a distance from a front vehicle, a pursuit acceleration amount, a maximum acceleration amount, a time point of a cut-out acceleration, and a time point of a cut-in deceleration.

13. The method of claim 11, wherein the generating of the patterns includes:
generating patterns of change based on at least one of a front vehicle distance, an acceleration, an acceleration time, or a deceleration time according to a change of a velocity of the vehicle from the data collected for the driving scenarios.

14. The method of claim 11, further comprising:
matching the patterns generated for the driving scenarios with reference patterns generated in advance according to the driving conditions.

15. The method of claim 14, wherein the matching of the patterns includes:
determining similarities of the patterns generated for the driving scenarios and the reference patterns to compare the patterns generated for the driving scenarios with the reference patterns and matching the patterns with a reference pattern, of the reference patterns, having a highest similarity.

16. The method of claim 11, wherein the collecting of the data includes:
determining a driving scenario, of the driving scenarios, that agrees with a driving condition, of the driving conditions, when the data is collected; and
storing the collected data in correspondence to the determined driving scenario.

17. The method of claim 11, wherein the collecting of the data is performed for every specific cycle until a preset data collection condition is satisfied.

18. The method of claim 11, wherein the determining of the control scenario includes:
determining the control scenario based on at least one of a target distance between a front vehicle and a host vehicle, presence of a front vehicle, a distance of the front vehicle, a target velocity of the host vehicle, a current velocity of the host vehicle, and a relative velocity of the front vehicle.

19. The method of claim 11, wherein the determining of the control scenario includes:
determining the control scenario for any one control situation of a front vehicle pursuit control, a target velocity pursuit control, and a cut-in deceleration control according to the current driving situation of the vehicle.

20. The method of claim 11, wherein the controlling of the driving of the vehicle includes:
determining at least one control parameter of a required acceleration, an acceleration delay time point, and a deceleration delay time point based on a pattern, of the patterns, corresponding to the at least one driving scenario, of the driving scenarios, matched with the control scenario; and
generating the control data based on the at least one control parameter.
